(19) United States
(12) Patent Application Publication
(10) Pub. No.: US 2026/0173135 A1
(43) Pub. Date: Jun. 18, 2026

(54) SYSTEM AND METHOD FOR WIRELESS COMMUNICATIONS

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Rui Cao, Sunnyvale, CA (US); Hongyuan Zhang, Fremont, CA (US)

(21) Appl. No.: 19/423,862

(22) Filed: Dec. 17, 2025

Related U.S. Application Data
(60) Provisional application No. 63/734,978, filed on Dec. 17, 2024.
(60) Provisional application No. 63/738,966, filed on Dec. 26, 2024.

(51) Int. Cl. H04W 74/0808

(52) U.S. Cl. CPC H04W 74/0808

(57) ABSTRACT

Embodiments of a method and apparatus for wireless communications are disclosed. In an embodiment, a wireless device includes a controller configured to generate an Initial Control Frame (ICF) or an Initial Control Reply (ICR) in a Transmission Opportunity (TXOP), where a selection of the ICF or the ICR is based on features being used in the TXOP, and a wireless transceiver configured to transmit the ICF or the ICR.

### CROSS-REFERENCE TO RELATED APPLICATIONS

This application is entitled to the benefit of U.S. Provisional Patent Application Ser. No. 63/734,978, filed on Dec. 17, 2024 and U.S. Provisional Patent Application Ser. No. 63/738,966, filed on Dec. 26, 2024, the contents of each of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. In an embodiment, a wireless device includes a controller configured to generate an Initial Control Frame (ICF) or an Initial Control Reply (ICR) in a Transmission Opportunity (TXOP), where a selection of the ICF or the ICR is based on features being used in the TXOP, and a wireless transceiver configured to transmit the ICF or the ICR. Other embodiments are also disclosed.

In an embodiment, the wireless transceiver is further configured to receive an Aggregate MAC Protocol Data Unit (A-MPDU) or a single MAC Protocol Data Unit (MPDU), the controller is further configured to generate a responding control frame that contains information regarding a reason why the A-MPDU or the single MPDU is not received correctly at the wireless device, and the wireless transceiver is further configured to transmit the responding control frame.

In an embodiment, the control responding frame includes a Multi-Station (STA) block acknowledgment (BA) frame.

In an embodiment, the information regarding the reason why the A-MPDU or the single MPDU is not received correctly at the wireless device comprises an indication of an in-device interference existence or not.

In an embodiment, the information regarding the reason why the A-MPDU or the single MPDU is not received correctly at the wireless device is carried in a block acknowledgment (BA) Control field by repurposing a reserved bit.

In an embodiment, a Feedback Per Association Identifier (AID) Traffic Identifier (TID) Information (Info) field carries the information regarding the reason why the A-MPDU or the single MPDU is not received correctly at the wireless device.

In an embodiment, the features being used in the TXOP include at least two of dynamic subband operation (DSO), dynamic power save (DPS), non-primary channel access (NPCA), control frame protection (CFP), enhanced multilink single-radio (eMLSR), and dynamic unavailability operation (DUO).

In an embodiment, with NPCA being used in the TXOP, the ICF includes a buffer status report poll (BSRP) non-trigger based (NTB) frame.

In an embodiment, with DSO being used in the TXOP, the ICF includes a buffer status report poll (BSRP) non-trigger based (NTB) frame if a TXOP responder has a padding requirement for DPS operation.

In an embodiment, when multiple features of dynamic subband operation (DSO), non-primary channel access (NPCA), control frame protection (CFP), dynamic power save (DPS), dynamic unavailability operation (DUO), and enhanced multilink single-radio (eMLSR) are applied to the TXOP, restrictions related to the multiple features are applied to an ICF in the TXOP.

In an embodiment, if DUO and at least another feature are used in the TXOP, the ICR includes a Multi-Station (STA) block acknowledgment (BA) frame or a quality of service (QoS) Null frame.

In an embodiment, if CFP and at least another feature is used in the TXOP, the ICR includes a Multi-Station (STA) block acknowledgment (BA) frame or a quality of service (QoS) Null frame.

In an embodiment, if at least two of NPCA, DSO, DPS, and EMLSR are used in the TXOP, the ICR solicited by an allowed ICF needs to satisfy all requirement of the features being used in the TXOP.

In an embodiment, a method for wireless communications involves at a wireless device, generating an Initial Control Frame (ICF) or an Initial Control Reply (ICR) in a Transmission Opportunity (TXOP), where a selection of the ICF or the ICR is based on features being used in the TXOP, and at the wireless device, transmitting the ICF or the ICR.

In an embodiment, the method further includes at the wireless device, receiving an Aggregate MAC Protocol Data Unit (A-MPDU) or a single MPDU, at the wireless device, generating a responding control frame that contains information regarding a reason why the received A-MPDU or the received single MPDU is not received correctly at the wireless device, and at the wireless device, transmitting the responding control frame.

In an embodiment, the control responding frame includes a Multi-Station (STA) block acknowledgment (BA) frame.

In an embodiment, the information regarding the reason why the A-MPDU or the single MPDU is not received correctly at the wireless device is carried in a block acknowledgment (BA) Control field by repurposing a reserved bit.

In an embodiment, the features being used in the TXOP include at least two of dynamic subband operation (DSO), dynamic power save (DPS), non-primary channel access (NPCA), control frame protection (CFP), enhanced multilink single-radio (eMLSR), and dynamic unavailability operation (DUO).

In an embodiment, when multiple features of dynamic subband operation (DSO), non-primary channel access (NPCA), control frame protection (CFP), dynamic power save (DPS), dynamic unavailability operation (DUO), and enhanced multilink single-radio (eMLSR) are applied to the TXOP, restrictions related to the multiple features are applied to an ICF in the TXOP.

In an embodiment, if DUO and at least another feature are used in the TXOP, the ICR includes a Multi-Station (STA) block acknowledgment (BA) frame or a quality of service (QoS) Null frame.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 depicts a responding control frame format in accordance with example embodiments.

FIG. 5 illustrates some communications between an AP and a wireless station (STA) in a transmit opportunity (TXOP) in accordance with example embodiments.

FIG. 6 is a process flow diagram of a method for wireless communications in accordance with example embodiments.

FIG. 7 is a process flow diagram of a method for wireless communications in accordance with example embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

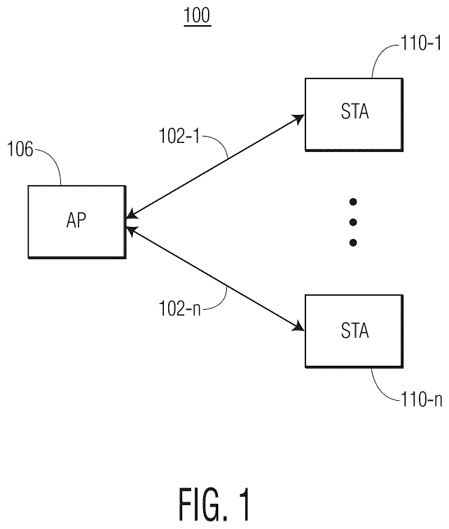

FIG. 1 depicts a wireless (e.g., WiFi) communications system 100 in accordance with example embodiments. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received PPDUs through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received PPDUs through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

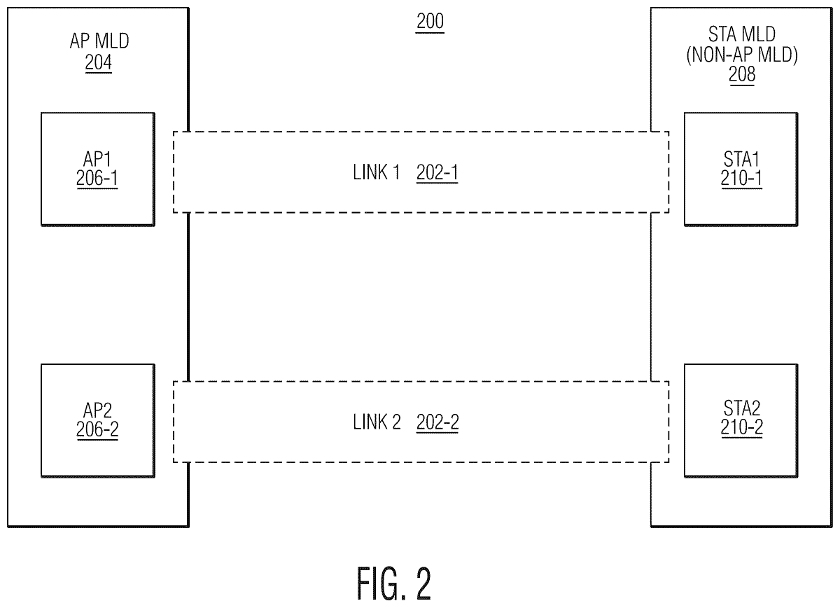

FIG. 2 depicts a multi-link (ML) communications system 200 that is used for wireless (e.g., WiFi) communications in accordance with example embodiments. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received PPDUs through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common upper layer MAC functionalities and the non-AP STAs 210-1 and 210-2 implement the upper layer MAC functionalities specific to a link and a lower layer MAC functionalities.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received PPDUs through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., data frames, beacon frames and the other management frames, control frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

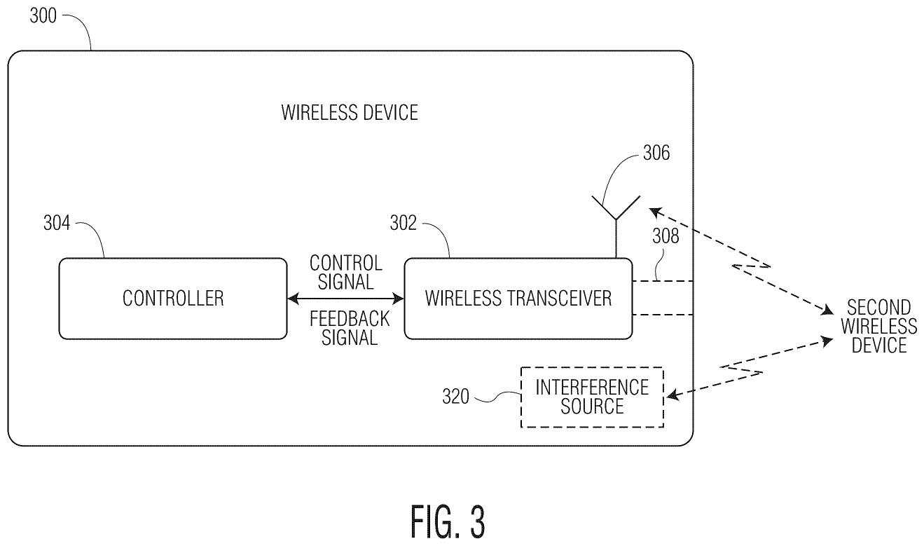

FIG. 3 depicts a wireless device 300 in accordance with example embodiments. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process PPDUs received through the antenna and/or the network port and/or to generate outgoing PPDUs to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

A wireless communications interference, such as an in-device interference source (e.g., one or more coexisting radio(s), such as, a Bluetooth transmitter) and/or an outside interference source, may interfere with a WLAN (e.g., Wi-Fi) transmitter because the WLAN (e.g., Wi-Fi) transmitter might not know for periodic activity or might not know for aperiodic activity beforehand when the interference may occur. A WLAN (e.g., Wi-Fi) device can announce that the device has one or more coexisting radios/transmitters and/or an outside interference source when performing the association or after the in-device coexisting radio(s) is turned on or turned off. In some embodiments, the activity of coexisting radios/transmitters and/or an outside interference source are link-level information. This information can help its connected WLAN (e.g., Wi-Fi) device to optimize rate adaptation in transmission. Knowing that a WLAN (e.g., Wi-Fi) receiver's error PPDUs are resulted from a coexisting interference and/or an outside interference source instead of a bad channel condition can improve wireless transmission throughput, for example, by preventing a WLAN (e.g., Wi-Fi) transmitter from dropping data PPDUs, resulting in a lower data rate.

In some embodiments, an interference source 320 is located within the wireless device 300. For example, the interference source 320 may be an in-device coexisting transmitter/radio (e.g., a Bluetooth transmitter/radio) and/or other internal interference source. In some embodiments, the wireless device 300 may further include a second wireless transceiver, and the interference source 320 includes the second wireless transceiver. In some embodiments, the wireless transceiver 302 is compatible with an Institute of Electrical and Electronics Engineers (IEEE) 802.11 protocol, while the second wireless transceiver is not compatible with the IEEE 802.11 protocol. For example, the second wireless transceiver may be compatible with a short range wireless communications protocol (e.g., a Bluetooth communications protocol). In some embodiments, an interference source is located outside of the wireless device 300. For example, an outside interference source, such as a wireless transmitter, may interfere with the wireless transceiver 302.

In accordance with an embodiment of the disclosure, the controller 304 is configured to generate an Initial Control Frame (ICF) or an Initial Control Reply (ICR) in a Transmission Opportunity (TXOP), where a selection of the ICF or the ICR is based on features being used in the TXOP, and the wireless transceiver 302 is configured to transmit the ICF or the ICR, for example, through the at least one antenna 306.

In some embodiments, a selection of the ICF is based on features being used in the TXOP and a selection of the ICR is based on the features being used in the TXOP and based on a soliciting ICF being received.

In some embodiments, the controller 304 is configured to generate an ICF and receive a solicited ICR or to transmit an ICR based on a received ICF in a TXOP, where the selection of ICF and ICR is based on the features being used in the TXOP.

In some embodiments, the wireless transceiver 302 is further configured to receive an Aggregate MAC Protocol Data Unit (A-MPDU) or a single MPDU, for example, through the at least one antenna 306, the controller 304 is further configured to generate a responding control frame that contains information regarding a reason why the A-MPDU or the single MPDU is not received correctly at the wireless device 300, and the wireless transceiver 302 is further configured to transmit the responding control frame, for example, through the at least one antenna 306.

The frames of the A-MPDU or the single MPDU may be received incorrectly at the wireless device 300 because of in-device interference or no in-device interference, which means that the reception error is introduced by the outside interference (e.g., channel errors, in-device and/or outside interference, and/or improper aggregation handling).

In some embodiments, the control responding frame includes a Multi-Station (STA) block acknowledgment (BA) frame.

In some embodiments, the information regarding the reason why the A-MPDU or the single MPDU is not received correctly at the wireless device comprises an indication of an in-device interference existence or not.

In some embodiments, the information regarding the reason why the A-MPDU or the single MPDU is not received correctly at the wireless device is carried in a block acknowledgment (BA) Control field by repurposing a reserved bit.

In some embodiments, a Feedback Per Association Identifier (AID) Traffic Identifier (TID) Information (Info) field carries the information regarding the reason why the A-MPDU or the single MPDU is not received correctly at the wireless device.

In some embodiments, the wireless device 300 includes a wireless station (STA), and the wireless transceiver 302 is further configured to receive the A-MPDU/MPDU from a transmit opportunity (TXOP) holder and to transmit the responding control frame to the TXOP holder.

In some embodiments, the information regarding the reason why the frames of the A-MPDU or the single MPDU are/is not received correctly at the wireless device 300 includes an indication of an in-device interference or no in-device interference.

In some embodiments, at least one reserved bit in a control field of the responding control frame is repurposed to carry the information regarding the reason why the frames of the A-MPDU or the single MPDU are/is not received correctly at the wireless device 300.

In some embodiments, the responding control frame is a multi-STA block acknowledgment (BA) frame where one reserved bit in a BA Control field is repurposed to carry the information regarding the reason why the frames of the A-MPDU or the single MPDU are/is not received correctly at the wireless device 300, a compressed BA frame where one reserved bit in a BA Control field is repurposed to carry the information regarding the reason why the frames of the A-MPDU are not received correctly at the wireless device 300, or a multi-traffic identifier (TID) BA frame where one reserved bit in a BA Control field is repurposed to carry the information regarding the reason why the frames of the A-MPDU are not received correctly at the wireless device 300.

In some embodiments, the responding control frame is the multi-STA BA frame where one reserved bit in the BA Control field is repurposed to carry the information regarding the reason why the frames of the A-MPDU or single received MPDU are/is not received correctly at the wireless device 300. In some embodiments, the responding control frame transmitted by a wireless STA can carry the reason why the frames of the A-MPDU or single received MPDU are/is not received correctly if/when the wireless STA supports a feature of dynamic unavailability operation (DUO).

In some embodiments, the features being used in the TXOP include at least two of dynamic subband operation (DSO), dynamic power save (DPS), non-primary channel access (NPCA), control frame protection (CFP), enhanced multilink single-radio (eMLSR), and dynamic unavailability operation (DUO).

In some embodiments, with NPCA being used in the TXOP, the ICF includes a buffer status report poll (BSRP) non-trigger based (NTB) frame.

In some embodiments, with DSO being used in the TXOP, the ICF includes a buffer status report poll (BSRP) non-trigger based (NTB) frame if/when a TXOP responder has a padding requirement for DPS operation.

In some embodiments, when multiple features of dynamic subband operation (DSO), non-primary channel access (NPCA), control frame protection (CFP), dynamic power save (DPS), dynamic unavailability operation (DUO), and enhanced multilink single-radio (eMLSR) are applied to the TXOP, restrictions related to the multiple features are applied to an initial control frame (ICF) in the TXOP.

In some embodiments, if/when DUO and at least another feature are used in the TXOP, the ICR includes a Multi-Station (STA) block acknowledgment (BA) frame or a quality of service (QoS) Null frame.

In some embodiments, if/when CFP and at least another feature is used in the TXOP, the ICR includes a Multi-Station (STA) block acknowledgment (BA) frame or a quality of service (QoS) Null frame.

In some embodiments, if/when at least two of NPCA, DSO, DPS, and EMLSR are used in the TXOP, the ICR solicited by an allowed ICF needs to satisfy all requirement of the features being used in the TXOP.

In some embodiments, the wireless transceiver 302 is further configured to generate and transmit an ICF in a TXOP based on whether the recipient(s) of the ICF use one or multiple of DPS, NPCA, DSO, EMLSR, CFP, DUO. In some embodiments, the wireless transceiver 302 is further configured to generate and transmit an ICR solicited by an ICF in a TXOP based on whether the recipient(s) of the ICF use one or multiple of DPS, NPCA, DSO, EMLSR, CFP, DUO.

In some embodiments, the wireless transceiver 302 is further configured to transmit one of a request to send (RTS), a multi-user (MU)-RTS, a buffer status report poll (BSRP) frame, and/or a BSRP non-trigger based (NTB) frame, for example, through the at least one antenna 306, to solicit the responding ICR, and receive, for example, through the at least one antenna 306, the responding CTS solicited by the RTS and MU-RTS, a Multi-STA BA solicited by the BSRP NTB frame, a Multi-STA BA frame solicited by the BSRP frame. In some embodiments, the wireless transceiver 302 is further configured to receive an RTS, a MU-RTS, a BSRP frame, and/or a BSRP NTB frame, for example, through the at least one antenna 306, and transmit through the at least one antenna 306 the responding clear to send (CTS) solicited by the RTS and MU-RTS, a Multi-STA BA solicited by the BSRP NTB frame, a Multi-STA BA solicited by the BSRP frame.

In some embodiments, the wireless device 300 is associated with a STA/AP affiliated with a wireless multi-link device (MLD).

In some embodiments, the wireless device 300 is compatible with an Institute of Electrical and Electronics Engineers (IEEE) 802.11 protocol.

In some embodiments, the wireless device 300 is associated with a wireless multi-link device (MLD), and the wireless transceiver 302 is further configured to conduct frame exchanges with a second wireless MLD through wireless links between the wireless MLD and the second wireless MLD.

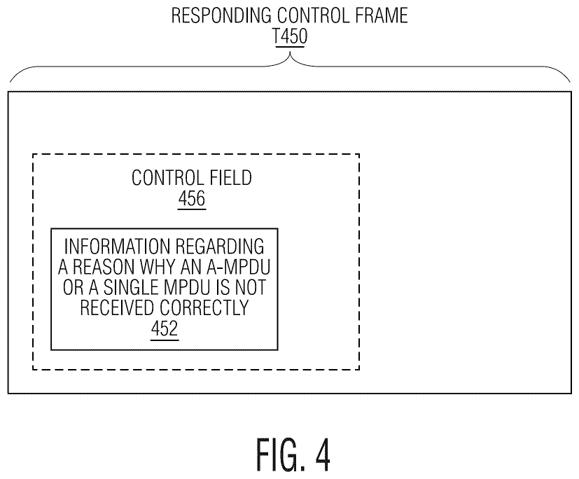

FIG. 4 depicts a responding control frame format 450 in accordance with example embodiments. The responding control frame format 450 illustrated in FIG. 4 can be used for communications by the wireless communications system 100 depicted in FIG. 1, by a STA/AP affiliated with the multi-link (ML) communications system 200 depicted in FIG. 2, and/or the wireless device 300 depicted in FIG. 3. In the embodiment depicted in FIG. 4, the responding control frame format 450 contains information 452 regarding a reason why an Aggregate MAC Protocol Data Unit (A-MPDU) or a single MPDU is not received correctly at a wireless device. In some embodiments, the information 452 is included in a control field 456. In some embodiments, the information 452 includes an indication of an in-device interference or no in-device interference. In some embodiments, the information 452 includes an indication of an indication of channel errors or improper aggregation handling. In some embodiments, the responding control frame 450 is a multi-STA block acknowledgment (BA) frame, a compressed BA frame, or a multi-traffic identifier (TID) BA frame. In some embodiments, the information 452 is carried in a repurposed reserved bit in BA Control field of Multi-STA BA.

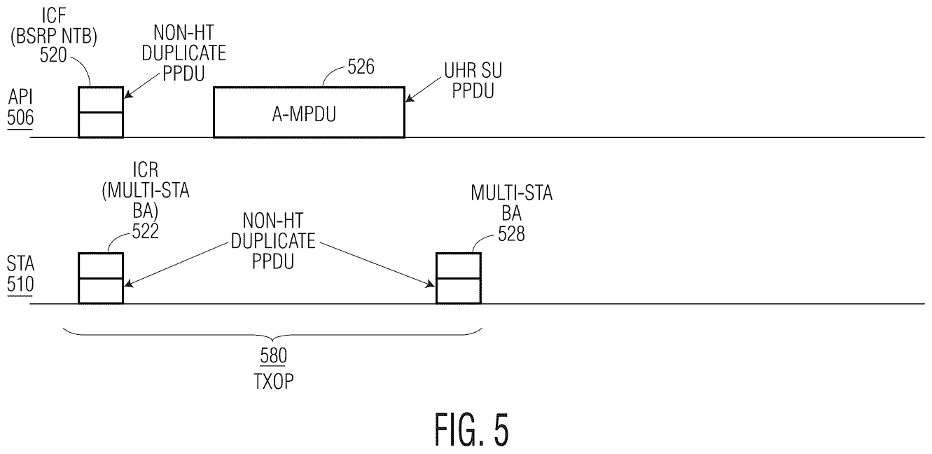

FIG. 5 illustrates some communications between an AP 506 and a wireless station (STA) 510 in a transmit opportunity (TXOP) 580 in accordance with example embodiments. The AP 506 depicted in FIG. 5 may be the same as or similar to an embodiment of the AP 106 depicted in FIG. 1, the APs 206-1, 206-2 depicted in FIG. 2, and/or the wireless device 300 depicted in FIG. 3. The STA 510 depicted in FIG. 5 may be the same as or similar to an embodiment of the STA 110-1, . . . , or 110-n depicted in FIG. 1, the STA 210-1 or 210-32 depicted in FIG. 2, and/or the wireless device 300 depicted in FIG. 3. As illustrated in FIG. 5, in a time sequence during the TXOP 580, the AP 506 transmits an initial control frame (ICF) 520, which may be a BSRP NTB frame, to the STA 510 and the STA 510 transmits an initial control response (ICR) 522, which may be a multi-STA BA frame, to the AP 506. In some embodiments, the ICR 522 includes 1) a multi-STA BA frame and/or QoS null frame solicited by BSRP or BSRP NTB, and/or 2) a CTS solicited by MU-RTS or RTS. In some embodiments, the ICF 520 is a BSRP trigger frame, a BSRP NTB frame, an MU-RTS frame or a RTS frame. In some embodiments, the selected ICF satisfies the enabled features' requirement of AP 506 as the TXOP holder and the requirement of the features used by the STA 510 as the TXOP responder in the TXOP. In some embodiments, the STA 510 transmits the ICR 522 that is one of Muti-STA BA+QoS Null, Multi-STA BA, CTS to the AP 506. In some embodiments, the selected ICR satisfies the enabled features' requirement of AP 506 as the TXOP holder and the requirement of the features used by the STA 510 as the TXOP responder in the TXOP. As illustrated in FIG. 5, subsequently, the AP 506 transmits an A-MPDU (Aggregated MAC Protocol Data Unit) 526, which may be an UHR single user (SU) PPDU, to the STA 510 and the STA 510 transmits a multi-STA BA frame 528 to the AP 506. In some embodiments, the ICF 520, the ICF 522, and the multi-STA BA frame 528 are non-HT (high throughput) duplicate PPDUs.

In some implementations, a multi-STA block acknowledgement (BA) that is solicited by an A-MPDU may carry the reason of in-device interference regarding why frames of an A-MPDU (Aggregated MAC Protocol Data Unit) are not received correctly. A responding Multi-STA BA can provide additional accurate information.

Some implementations for exchanging ICF/ICR or carrying link adaptation information, for example, performed by the wireless communications system 100 depicted in FIG. 1, the AP/STA of the multi-link (ML) communications system 200 in a link depicted in FIG. 2, the wireless device 300 depicted in FIG. 3, and/or the AP 506 and/or the wireless station (STA) 510 depicted in FIG. 5 are described.

In some embodiments, in Option 1, when a station (STA) supports in-device coexistence, e.g., dynamic unavailability operation (DUO), the reason of in-device interference that has influence to frame reception of an A-MPDU or a single MPDU or no in-device interference can be reported. In some embodiments, the reason of in-device interference or no in-device interference (one bit) or the other reasons (with more reserved bits being used) about why the frames of an A-MPDU or a single MPDU are/is not received correctly can be generalized. In some embodiments, one or multiple reserved bits in a BA Control field are repurposed to carry the reason why the frames in a soliciting A-MPDU or single MPDU are/is not received correctly. In some embodiments, either of a Multi-STA BA, a compressed BA, and a multi-TID (Traffic Identifier) BA can carry such information if an A-MPDU is received.

In some embodiments, in Option 2, when a STA supports in-device coexistence, e.g., DUO, the reason of in-device interference that has influence to frame reception or no in-device interference can be reported. In some embodiments, the reason to in-device interference or no in-device interference (one bit) or the other reasons (with more reserved bits being used) about why the frames of an A-MPDU or a single MPDU are/is not received correctly can be generalized. In some embodiments, one or multiple reserved bits in a BA Control field are repurposed to carry the reason why the frames in a soliciting A-MPDU are not received correctly. In some embodiments, a Multi-STA BA can replace an acknowledgment (Ack), a compressed BA, or a multi-TID BA if DUO is enabled for coexistence where the reason of the failed A-MPDU reception may need to be reported. In some embodiments, a TXOP holder allocates enough resource for the responding Multi-STA BA. In some embodiments, the interference report is carried in a Feedback Per AID TID Info field with the Feedback Type field indicates the interference report.

In some implementations, for control frame selection versus MAC features, the following features define new control frame selection rules because of one of receiver (Rx) capability restriction, feedback carrying, padding requirement, PPDU decoding restriction, frame protection, resource unit (RU) index coding ambiguity removing:
DPS (dynamic power save);
dynamic unavailability operation (DUO)for In-Device Coexistence (IDC):
   Solicited feedback,
   Unsolicited feedback;
DSO (dynamic subband operation);
Control frame protection (CFP);
NPCA (non primary channel access);
eMLSR (enhanced multi-link single radio).

Some examples of a single feature being applied in a TXOP are described as follows.

Some implementations for clarification of DPS, for example, performed by the wireless communications system 100 depicted in FIG. 1, the AP/STA of the multi-link (ML) communications system 200 in a link depicted in FIG. 2, the wireless device 300 depicted in FIG. 3, and/or the AP 506 and/or the wireless STA 510 depicted in FIG. 5 are described.

In some embodiments, in uplink (UL) direction, if/when a padding requirement is required by the addressed AP, a Buffer Status Report Poll (BSRP) Non-Triggered based (NTB) trigger frame solicits a Multi-STA BA in a non-HT duplicate PPDU. Otherwise, RTS (request to send) to solicit CTS (clear to send) is allowed.

In some embodiments, in downlink (DL) direction, with the recipient's padding requirement, multi-user (MU)-RTS to solicit CTS or a BSRP Trigger to solicit Quality of service (QoS) Null are allowed. Otherwise, MU-RTS to solicit CTS, a BSRP Trigger to solicit Quality of service (QoS) Null, or RTS to solicit CTS is allowed.

Some implementations for NPCA clarification, for example, performed by the wireless communications system 100 depicted in FIG. 1, the AP/STA of the multi-link (ML) communications system 200 in a link depicted in FIG. 2, the wireless device 300 depicted in FIG. 3, and/or the AP 506 and/or the wireless STA 510 depicted in FIG. 5 are described.

In an observation, in an UL soliciting case with none of DPS, DUO, CFP used in a TXOP, the primary channel's initial frame exchange of RTS/CTS is disallowed in the NPCA primary channel.

In some embodiments, in a solution, in an UL soliciting case with none of DPS, DUO, CFP used in a TXOP, BSRP NTB soliciting Multi-STA BA (M-BA) in a non-HT (duplicate) PPDU is applied. In some embodiments, in a solution, in an DL soliciting case with none of DPS, DUO, CFP used in a TXOP, one of the BSRP that solicits QoS Null and MU-RTS that solicits CTS is applied.

Some implementations for Clarification of BSRP Soliciting M-BA+QoS Null, for example, performed by the wireless communications system 100 depicted in FIG. 1, the AP/STA of the multi-link (ML) communications system 200 in a link depicted in FIG. 2, the wireless device 300 depicted in FIG. 3, and/or the AP 506 and/or the wireless STA 510 depicted in FIG. 5 are described.

In some embodiments, a BSRP NTB frame that solicits Multi-STA BA in SU PPDU can be used for DUO if the BSRP NTB frame is transmitted by the AP or STA. Additionally, a BSRP frame as the ICF can also be used for DUO if the AP transmits ICF. Some examples of the case of BSRP Trigger soliciting TB PPDU under CFP or DUO are described as follows.

In some embodiments, in Option 1, a BSRP trigger frame is used as initial control frame (ICF) (first frame in a TXOP or first frame addressed to a STA in a TXOP). In some embodiments, if/when a TXOP responder addressed by the BSRP trigger frame enables the QoS Data frames in a trigger-based (TB) PPDU, the BSRP trigger frame as the ICF solicits a Multi-STA BA frame and a QoS Null frame from the TXOP responder enabling control frame protection. In such case, a BSRP trigger frame allocates resource enough for a TXOP responder to transmit a Multi-STA BA frame and a QoS Null frame. In some embodiments, if/when a TXOP responder addressed by the BSRP trigger frame enables the frames other than data frames in a TB PPDU (e.g., UL MU Data Disable equal to 1, UL MU Disable equal to 0), the BSRP trigger frame as ICF solicits a Multi-STA BA frame from the TXOP responder enabling control frame protection. In such case, the BSRP trigger frame allocates resource enough for a TXOP responder to transmit the Multi-STA BA frame. In some embodiments, the TXOP responder that enables its QoS Data frames in a TB PPDU and is solicited by a BSRP trigger frame as ICF transmits a QoS Null frame and a Multi-STA BA frame in the TB PPDU. In some embodiments, the TXOP responder that does not enables the frames other than Data frames in a TB PPDU and is solicited by a BSRP trigger frame as ICF transmits a Multi-STA BA frame in the TB PPDU.

In some embodiments, in Option 2, a BSRP trigger frame is used as ICF (first frame in a TXOP or first frame addressed to a STA in a TXOP). In some embodiments, the STA that enables DUO and/or CFP always conducts or performs the transmission of enable frame in a TB PPDU besides BSRP NTB as ICF under DUO. In some embodiments, a BSRP trigger frame as ICF allocates resource enough for a TXOP responder to transmit a Multi-STA BA frame and a QoS Null frame in the TB PPDU. In some embodiments, the TXOP responder solicited by a BSRP trigger frame as ICF transmits a QoS Null frame and a Multi-STA BA frame in a TB PPDU.

In some embodiments, in Option 3, a BSRP trigger frame is used as ICF (first frame in a TXOP or first frame addressed to a STA in a TXOP) (similar to Option 2 except that QoS Null is optional). In some embodiments, the STA that enables DUO and/or CFP always conducts or performs the transmission of enable frame in a TB PPDU besides BSRP NTB as ICF under DUO. In some embodiments, a BSRP trigger frame as ICF solicits a Multi-STA BA frame and a QoS Null frame from a TXOP responder enabling control frame protection. In some embodiments, a BSRP trigger frame allocates resource enough for a TXOP responder to transmit a Multi-STA BA frame and an optional QoS Null frame. In some embodiments, the TXOP responder solicited by a BSRP trigger frame transmits a Multi-STA BA frame and an optional QoS Null frame in a TB PPDU. In some embodiments, in a variant to a responding Multi-STA BA frame and an optional QoS Null frame carrying buffer status in a TB PPDU is that the Multi-STA BA frame carrying buffer status (besides unavailable information if required) in the TB PPDU.

Some examples of the Case of BSRP Trigger other than ICF under CFP are described as follows.

In some embodiments, in option 1 of a BSRP trigger frame other than in the first frame exchange, in a TXOP other than the first frame exchange, the protected BSRP trigger frame solicits a QoS Null frame in a TB PPDU only. In some embodiments, the protected BSRP trigger allocates resource enough for a TXOP responder enabling control frame protection to transmit the QoS Null frame. In some embodiments, the TXOP responder enabling control frame protection transmits the QoS Null frame.

In some embodiments, in option 2 of a BSRP trigger frame other than in the first frame exchange, if/when a TXOP responder addressed by the BSRP trigger frame supports QoS Data frames in a TB PPDU, the BSRP trigger frame solicits a Multi-STA BA frame and a QoS Null frame from the TXOP responder enabling control frame protection. In some embodiments, the BSRP trigger frame allocates resource enough for a TXOP responder to transmit the Multi-STA BA frame and the QoS Null frame.

In some embodiments, in option 3 of a BSRP trigger frame other than in the first frame exchange, the BSRP trigger frame solicits a Multi-STA BA frame and a QoS Null frame from the TXOP responder enabling control frame protection. In some embodiments, the BSRP trigger frame allocates resource enough for a TXOP responder to transmit the Multi-STA BA frame and the QoS Null frame.

In some embodiments, in option 4 of a BSRP trigger frame other than in the first frame exchange, it is similar to option 2 with the following variant: the Multi-STA BA frame carries buffer status report besides unavailable information.

Some implementations for Clarification of BSRP under CFP, for example, performed by the wireless communications system 100 depicted in FIG. 1, the AP/STA of the multi-link (ML) communications system 200 in a link depicted in FIG. 2, the wireless device 300 depicted in FIG. 3, and/or the AP 506 and/or the wireless STA 510 depicted in FIG. 5 are described.

Some examples of TB PPDU carrying responding frame solicited by BSRP Trigger are described as follows.

In some embodiments, in option 1 of a BSRP trigger frame, in a TXOP, the protected BSRP trigger frame solicits a QoS Null frame only. In some embodiments, the protected BSRP trigger frame allocates resource enough for a TXOP responder enabling control frame protection to transmit the QoS Null frame. In some embodiments, the TXOP responder enabling control frame protection transmits the QoS Null frame in a TB PPDU.

In some embodiments, in option 2 of a BSRP trigger frame, in a TXOP, the protected BSRP trigger frame as ICF solicits a protected Multi-STA BA frame and a QoS Null frame from a TXOP responder enabling control frame protection. In some embodiments, the protected BSRP trigger frame allocates resource enough for a TXOP responder enabling control frame protection to transmit the protected Multi-STA BA frame and the QoS Null frame. In some embodiments, the TXOP responder transmits the QoS Null frame and the protected Multi-STA BA frame in the TB PPDU.

In some embodiments, in option 3 of a BSRP trigger frame, it is similar to option 2 with the following variant: a Multi-STA BA frame carries channel available information besides unavailable information.

Some examples of multiple features being applied in a TXOP are described as follows.

Some implementations for ICF, ICR under Multiple Features being Applied to a TXOP, for example, performed by the wireless communications system 100 depicted in FIG. 1, the AP/STA of the multi-link (ML) communications system 200 in a link depicted in FIG. 2, the wireless device 300 depicted in FIG. 3, and/or the AP 506 and/or the wireless STA 510 depicted in FIG. 5 are described.

For a TXOP holder's ICF selection rule, in some embodiments, when multiple features of DSO, NPCA, CFP, DPS, DUO and EMLSR are applied to a TXOP, all the restrictions of the ICF related to the multiple features are applied to the ICF. In some embodiments, if/when one feature does not allow a control frame as the ICF, the control frame is not considered as the ICF.

For the TXOP responder's ICR+QoS Null selection rule, In some embodiments, when DUO and at least another feature are applied to a TXOP responder, the restrictions of a Multi-STA BA+QoS Null and a Multi-STA BA (M-BA) related to DUO are applied. In some embodiments, if solicited by a downlink (DL) BSRP frame as the ICF, M-BA+QoS Null in a TB PPDU will be used since the TB PPDU is the responding PPDU. In some embodiments, if solicited by a downlink (DL) BSRP NTB frame as the ICF, an M-BA frame in non-HT (duplicate) PPDU (or non-TB PPDU) will be used. In some embodiments, if solicited by a DL BSRP NTB as the ICF, an M-BA frame in non-HT (duplicate) PPDU will be used.

In some embodiments, when NPCA and at least another one of CFP, DPS and eMLSR are applied to a TXOP responder, the other features' restriction of ICR is applied.

In some embodiments, when multiple features of DSO, DPS, CFP are applied to a TXOP responder, under the selected ICF, all restrictions of the ICR related to the multiple features are applied the is solicited by the ICF, i.e. if one feature does not allow a frame as ICR, the frame cannot be used as the ICR.

Some implementations for ICF/ICR (Initial Control Response) Clarification with DUO and at least another feature of EMLSR/DPS/NPCA being enabled and used in a TXOP, for example, performed by the wireless communications system 100 depicted in FIG. 1, the AP/STA of the multi-link (ML) communications system 200 in a link depicted in FIG. 2, the wireless device 300 depicted in FIG. 3, and/or the AP 506 and/or the wireless STA 510 depicted in FIG. 5 are described.

In some embodiments, in Option 1, a BSRP NTB from an AP is disallowed and a Multi-STA BA frame in non-HT (duplicate) PPDU (or in non-TB PPDU as another option) is disallowed to be used as a responding frame of a BSRP NTB frame from AP if 1), DUO is enabled and 2) DPS or EMLSR is used in the TXOP.

In some embodiments, in Option 2, a BSRP NTB from an AP is allowed and a Multi-STA BA frame in non-HT (duplicate) PPDU (or in non-TB PPDU as another option) is allowed to be used as responding frame of a BSRP NTB Trigger if 1), DUO is enabled and 2) DPS, NPCA or EMLSR is used in the TXOP.

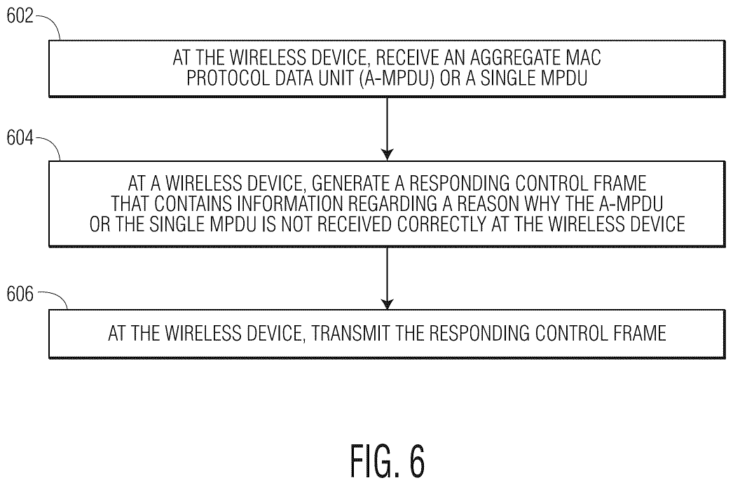

FIG. 6 is a process flow diagram of a method for wireless communications in accordance with example embodiments. At block 602, at a wireless device, an Aggregate MAC Protocol Data Unit (A-MPDU) or a single MPDU is received. At block 604, at the wireless device, a responding control frame that contains information regarding a reason why the received A-MPDU or the received single MPDU is not received correctly at the wireless device is generated. At block 606, at the wireless device, the responding control frame is transmitted. In some embodiments, the control responding frame includes a Multi-Station (STA) block acknowledgment (BA) frame. In some embodiments, the information regarding the reason why the A-MPDU or the single MPDU is not received correctly at the wireless device includes an indication of an in-device interference existence or an outside interreference. In some embodiments, the information regarding the reason why the A-MPDU or the single MPDU is not received correctly at the wireless device is carried in a block acknowledgment (BA) Control field by repurposing a reserved bit. In some embodiments, a Feedback Per Association Identifier (AID) Traffic Identifier (TID) Information (Info) field carries the information regarding the reason why the A-MPDU or the single MPDU is not received correctly at the wireless device. In some embodiments, the wireless device is compatible with an Institute of Electrical and Electronics Engineers (IEEE) 802.11 protocol. The wireless device may be the same as or similar to an embodiment of the AP 106 and/or the STAs 110-1, . . . , 110-n depicted in FIG. 1, the APs 206-1, 206-2 and/or the STAs 210-1, 210-2 depicted in FIG. 2, the wireless device 300 depicted in FIG. 3, and/or the AP 506 and/or the wireless STA 510 depicted in FIG. 5.

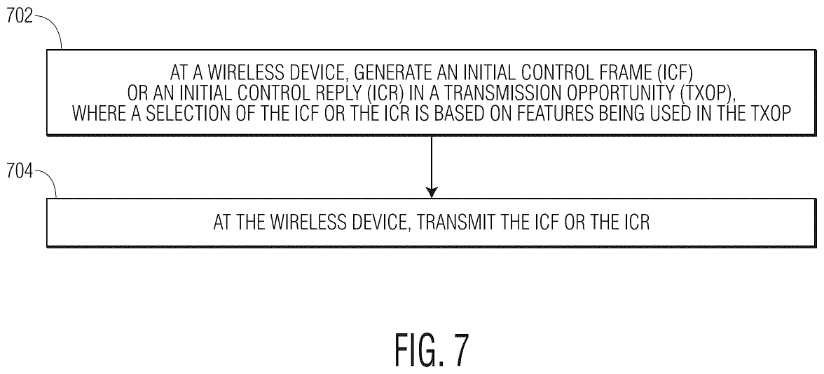

FIG. 7 is a process flow diagram of a method for wireless communications in accordance with example embodiments. At block 702, at a wireless device, an Initial Control Frame (ICF) or an Initial Control Reply (ICR) is generated in a Transmission Opportunity (TXOP), where a selection of the ICF or the ICR is based on features being used in the TXOP. In some embodiments, a selection of the ICF is based on features being used in the TXOP and a selection of the ICR is based on the features being used in the TXOP and based on a soliciting ICF being received. At block 704, at the wireless device, the ICF or the ICR is transmitted. In some embodiments, at the wireless device, an Aggregate MAC Protocol Data Unit (A-MPDU) or a single MPDU is received, at the wireless device, a responding control frame that contains information regarding a reason why the received A-MPDU or the received single MPDU is not received correctly at the wireless device is generated, and at the wireless device, the responding control frame is transmitted. In some embodiments, the control responding frame comprises a Multi-Station (STA) block acknowledgment (BA) frame. In some embodiments, the information regarding the reason why the A-MPDU or the single MPDU is not received correctly at the wireless device is carried in a block acknowledgment (BA) Control field by repurposing a reserved bit. In some embodiments, the features being used in the TXOP include at least two of dynamic subband operation (DSO), dynamic power save (DPS), non-primary channel access (NPCA), control frame protection (CFP), enhanced multilink single-radio (eMLSR), and dynamic unavailability operation (DUO). In some embodiments, when multiple features of dynamic subband operation (DSO), non-primary channel access (NPCA), control frame protection (CFP), dynamic power save (DPS), dynamic unavailability operation (DUO), and enhanced multilink single-radio (eMLSR) are applied to the TXOP, restrictions related to the multiple features are applied to an ICF in the TXOP. In some embodiments, if DUO and at least another feature are used in the TXOP, the ICR includes a Multi-Station (STA) block acknowledgment (BA) frame or a quality of service (QoS) Null frame. In some embodiments, the wireless device is compatible with an Institute of Electrical and Electronics Engineers (IEEE) 802.11 protocol. The wireless device may be the same as or similar to an embodiment of the AP 106 and/or the STAs 110-1, . . . , 110-n depicted in FIG. 1, the APs 206-1, 206-2 and/or the STAs 210-1, 210-2 depicted in FIG. 2, the wireless device 300 depicted in FIG. 3, and/or the AP 506 and/or the wireless STA 510 depicted in FIG. 5.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a controller configured to generate an Initial Control Frame (ICF) or an Initial Control Reply (ICR) in a Transmission Opportunity (TXOP), wherein a selection of the ICF or the ICR is based on a plurality of features being used in the TXOP; and
a wireless transceiver configured to transmit the ICF or the ICR.

2. The wireless device of claim 1, wherein the wireless transceiver is further configured to receive an Aggregate MAC Protocol Data Unit (A-MPDU) or a single MPDU, wherein the controller is further configured to generate a responding control frame that contains information regarding a reason why the A-MPDU or the single MPDU is not received correctly at the wireless device, and wherein the wireless transceiver is further configured to transmit the responding control frame.

3. The wireless device of claim 2, wherein the control responding frame comprises a Multi-Station (STA) block acknowledgment (BA) frame.

4. The wireless device of claim 2, wherein the information regarding the reason why the A-MPDU or the single MPDU is not received correctly at the wireless device comprises an indication of an in-device interference existence or not.

5. The wireless device of claim 2, wherein the information regarding the reason why the A-MPDU or the single MPDU is not received correctly at the wireless device is carried in a block acknowledgment (BA) Control field by repurposing a reserved bit.

6. The wireless device of claim 2, wherein a Feedback Per Association Identifier (AID) Traffic Identifier (TID) Information (Info) field carries the information regarding the reason why the A-MPDU or the single MPDU is not received correctly at the wireless device.

7. The wireless device of claim 1, wherein the features being used in the TXOP comprise at least two of dynamic subband operation (DSO), dynamic power save (DPS), non-primary channel access (NPCA), control frame protection (CFP), enhanced multilink single-radio (eMLSR), and dynamic unavailability operation (DUO).

8. The wireless device of claim 7, wherein with NPCA being used in the TXOP, the ICF comprises a buffer status report poll (BSRP) non-trigger based (NTB) frame.

9. The wireless device of claim 7, wherein with DSO being used in the TXOP, the ICF comprises a buffer status report poll (BSRP) non-trigger based (NTB) frame if a TXOP responder has a padding requirement for DPS operation.

10. The wireless device of claim 1, wherein when multiple features of dynamic subband operation (DSO), non-primary channel access (NPCA), control frame protection (CFP), dynamic power save (DPS), dynamic unavailability operation (DUO), and enhanced multilink single-radio (eMLSR) are applied to the TXOP, a plurality of restrictions related to the multiple features are applied to an ICF in the TXOP.

11. The wireless device of claim 10, wherein if DUO and at least another feature are used in the TXOP, the ICR includes a Multi-Station (STA) block acknowledgment (BA) frame or a quality of service (QoS) Null frame.

12. The wireless device of claim 10, wherein if CFP and at least another feature is used in the TXOP, the ICR includes a Multi-Station (STA) block acknowledgment (BA) frame or a quality of service (QoS) Null frame.

13. The wireless device of claim 10, wherein if at least two of NPCA, DSO, DPS, and EMLSR are used in the TXOP, the ICR solicited by an allowed ICF needs to satisfy all requirement of the features being used in the TXOP.

14. A method for wireless communications, the method comprising:
at a wireless device, generating an Initial Control Frame (ICF) or an Initial Control Reply (ICR) in a Transmission Opportunity (TXOP), wherein a selection of the ICF or the ICR is based on a plurality of features being used in the TXOP; and
at the wireless device, transmitting the ICF or the ICR.

15. The method of claim 14, further comprising:
at the wireless device, receiving an Aggregate MAC Protocol Data Unit (A-MPDU) or a single MPDU;
at the wireless device, generating a responding control frame that contains information regarding a reason why the A-MPDU or the single MPDU is not received correctly at the wireless device; and
at the wireless device, transmitting the responding control frame.

16. The method of claim 15, wherein the control responding frame comprises a Multi-Station (STA) block acknowledgment (BA) frame.

17. The method of claim 15, wherein the information regarding the reason why the A-MPDU or the single MPDU is not received correctly at the wireless device is carried in a block acknowledgment (BA) Control field by repurposing a reserved bit.

18. The method of claim 14, wherein the features being used in the TXOP comprise at least two of dynamic subband operation (DSO), dynamic power save (DPS), non-primary channel access (NPCA), control frame protection (CFP), enhanced multilink single-radio (eMLSR), and dynamic unavailability operation (DUO).

19. The method of claim 14, wherein when multiple features of dynamic subband operation (DSO), non-primary channel access (NPCA), control frame protection (CFP), dynamic power save (DPS), dynamic unavailability operation (DUO), and enhanced multilink single-radio (eMLSR) are applied to the TXOP, a plurality of restrictions related to the multiple features are applied to an ICF in the TXOP.

20. The method of claim 19, wherein if DUO and at least another feature are used in the TXOP, the ICR includes a Multi-Station (STA) block acknowledgment (BA) frame or a quality of service (QoS) Null frame.
